(19) United States
(12) Patent Application Publication
(10) Pub. No.: US 2014/0244749 A1
(43) Pub. Date: Aug. 28, 2014

(54) PERSONAL DATA CHANNEL

(71) Applicant: HEWLETT-PACKARD DEVELOPMENT COMPANY, L.P., Houston, TX (US)

(72) Inventors: Robert P. Martin, Fort Collins, CO (US); Paul W. Martin, Loveland, CO (US)

(73) Assignee: Hewlett-Packard Development Company, L.P., Houston, TX (US)

(21) Appl. No.: 13/779,891

(22) Filed: Feb. 28, 2013

(51) Int. Cl. H04L 29/06

(52) U.S. Cl. CPC H04L 65/602
USPC 709/204

(57) ABSTRACT

An example method for sharing a personal data channel in accordance with the present disclosure includes collecting a selection of personal data associated with a user, synthesizing a personal data channel using the selected personal data, and delivering the personal data channel to at least one multimedia device.

### BACKGROUND

Computer networks and local area networks are widely used for communication of a variety of information among content sources and content consumers. The information communicated from a content source to a content consumer may include text, music, video, telephone calls, digital files, or other information that is broadly termed “content.” Such content may include personal data.

Sharing personal content has become universally popular. For example, a content owner may choose to attach a photo or video file to an email message, or use an internet website that enables the content owner to share the content by uploading it to the website.

Channels are used for viewing public media content in home entertainment systems. For example, a multimedia device provides access to a plurality of channels, including channels directed to sports, holiday classics, news programs, and television shows. The media content provided commercially for home entertainment systems is selected and produced by the multimedia service provider, for example a cable or satellite provider.

### BRIEF DESCRIPTION OF THE DRAWINGS

Examples are described in the following detailed description and in reference to the drawings, in which:

FIG. 1 illustrates an example system in accordance with an implementation;

FIG. 2 illustrates an example synthesizer in an example system in accordance with an implementation;

FIG. 3 illustrates an example channel in accordance with an implementation;

FIG. 4 illustrates an example process flow diagram in accordance with another implementation; and

FIG. 5 illustrates an example process flow diagram in accordance with another implementation.

### DETAILED DESCRIPTION

Various aspects of the present disclosure are generally directed to communication of data using communication networks. More specifically, various aspects of the present disclosure are directed to enabling a user to create a data channel using personal data and to stream such data to a group of viewers. As described in greater detail below, personal data may be shared between parties through a personal channel that is synthesized on a personal device or on a plurality of devices, and the channel is shared directly with another device or through a cloud transport. This approach allows the user to create a personal channel based on selected personal content without limiting the content to one type of data.

Aspects of the present disclosure described herein designate a select group of private recipients to receive personal media content over a private channel that is made available only to the select group of private recipients. Among other things, this approach may prevent the personal data from becoming public.

In one example in accordance with the present disclosure, a method for sharing a personal data channel is provided. The method comprises collecting a selection of personal data associated with a user, synthesizing, at a user device, a personal data channel using the selected personal data, and delivering the personal data channel to at least one multimedia device.

In another example in accordance with the present disclosure, a system is provided. The system comprises a content module to collect a selection of personal data associated with a user, and a channel module to synthesize, at a multimedia device, a personal data channel using the collected personal data.

In a further example in accordance with the present disclosure, a non-transitory computer readable medium is provided. The non-transitory computer-readable medium comprises instructions which, when executed, cause a device to (i) collect a selection of personal data associated with a user, (ii) synthesize, at a user device, a personal data channel using the selected personal data; and (iii) deliver the personal data channel to at least one multimedia device.

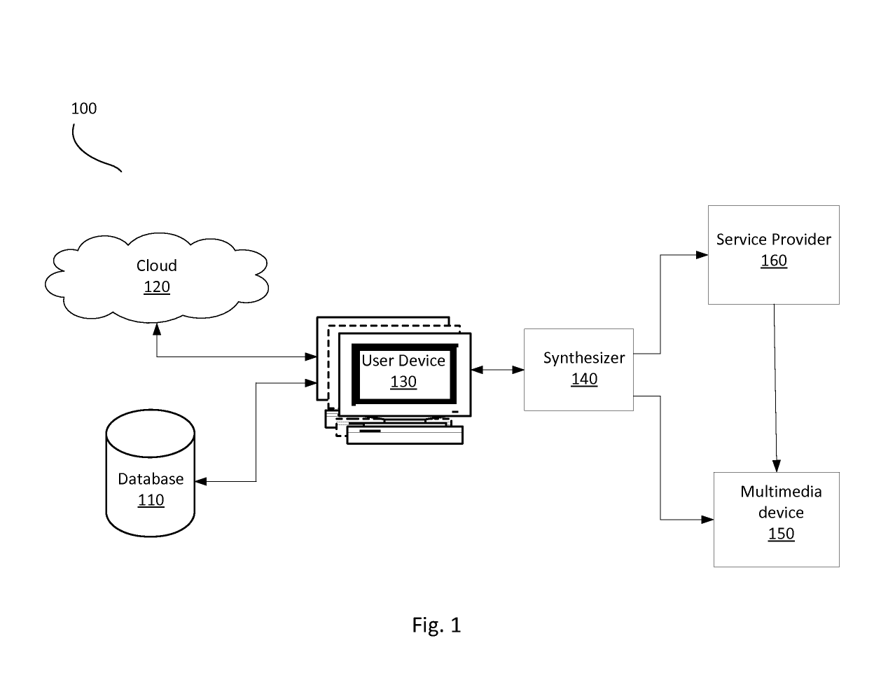

FIG. 1 illustrates an example system 100 in accordance with an implementation. It should be readily apparent that the present illustration should not be interpreted to be limited by this particular illustrative architecture shown in FIG. 1, and the system 100 represents a generalized illustration and that other elements may be added or existing elements may be removed, modified, or rearranged without departing from the scope of the present disclosure. For example, while the system 100 depicted in FIG. 1 includes only one multimedia device, the system may actually comprise a plurality of multimedia devices, and only one has been shown and described for simplicity.

The system 100 comprises a database 110, a cloud 120, at least one user computer 130, a synthesizer 140, a multimedia device 150 and a service provider 160.

The system 100 may be a peer-to-peer sharing environment, in which there may be distributed architecture without the need for central coordination, with user devices and multimedia devices being at the same time both suppliers and consumers of data objects. Peer-to peer (P2P) technology created a means for sharing information without requiring that all information be saved on a central, hosted server, providing direct connections between data sources and offered either access to files or replication of files. In another implementation, the system 100 may be a cloud-based sharing system, which uses computing resources (hardware and software) that are delivered as a service over a network (e.g., the Internet). The cloud-based system exposes data to be accessed by user devices as a service over a network, and accordingly the user devices may be connected to each other through the cloud. One of the cloud architectures is indicated in FIG. 1 by the cloud 120. The cloud 120 may replace, supplement, or blend with features and capabilities provided by applications and software that run locally. Applications may include, for example, one or more of identity and directory services, device management and security, synchronized storage and data services across multiple devices or platforms, and services pertaining to activities and news. Moreover, even though it is not shown in FIG. 1, the user device 130 along with the synthesizer 140 may be connected to the multimedia device 150 and/or the service provider 160 through a cloud.

Alternatively or in addition, communications medium between the user devices may include, but is not limited to, any combination of wired and/or wireless resources. For example, communications medium may include resources provided by any combination of cable television networks, direct video broadcasting networks, satellite networks, cellular networks, wired telephony networks and/or data networks, wireless data networks (e.g., wireless local area networks, wireless personal area networks, etc.), and so forth.

The database 110 may contain personal content associated with a user. While FIG. 1 illustrates one database, the database 110 may be configured differently. For example, the database 110 may be split into more than one database. According to an exemplary implementation, the database 110 may contain a sub-database. In one implementation, the database 110 may be connected to the user device 130. In another implementation, the database 110 may be locally stored at the premises of the user's device 130 and content may be provided with one or more suitable interfaces. Further, the system 100 may consist of a number of databases and modules with specific functions. The databases and modules of the system may be separately stored/implemented in different machines or at the same machine.

It should be understood that content described herein may have a broader meaning, and implementations described herein are applied to a plurality of content types, such as and not limited to, audio files, images, games, news feeds, story feeds, blogs, electronic books including machine-readable books, etc. For example, the personal content may be a collection of personal assets which may include, but not limited to, digital or analog photos from local systems, Facebook, Flickr, Snapfish, tweets, RSS feeds, photo-derived artifacts (books, collages, animated sequences), personal videos, personally-selected RSS feeds, Facebook updates, and publicly shared scheduled items or events.

The content in the database 110 may have content information associated with the content. According to example implementations, content information may comprise content identifier, content title/name, content type (e.g., video, image, audio, story feeds, etc.), content description, and relevant keywords for content search. According to another implementation, content information may indicate whether content is user-created or owned. According to example implementations, content information may also comprise playback duration in case of video and audio content, and content size. According to another aspect, content information may also include user views on the content and user ratings.

Content may be available in different formats. For example, digital images may be in a format of JPEG, GIF, PNG, etc. Audio content may be in a format of MP3, WAV, WMA, etc. Video content may be in a format of MPEGx, H.264, AVS, AVI, etc. The content may be one type or a mix of a plurality of types. The term “data type” as used herein, may mean the various formats that content are typically stored in or presented through. If the user wishes to present still photos over a personal media channel, then the user may have still pictures (e.g., .JPEG) as the data type. A photo slideshow format represents another data type. Videos may be selected as another unique data type, as well as music files, which also represent a unique data type.

Alternatively or in addition to the database 110, personal data may be acquired from the cloud 120. The cloud 120 may comprise of a worldwide interconnected internetworks. The term “network” refers to one or more local area networks, wide area networks, virtual private networks, or the worldwide interconnected internetworks known as the Internet.

The user device 130 may be a personal computer, laptop computer, and mobile device. In one implementation, the system 100 may have a plurality of devices, and the devices may be viewed as peer devices on a mesh where data may be moved across the devices (i.e., fetched). In another implementation, all devices may be arranged to connect to one another through a cloud. Depending on the implementation, security features/tools may be implemented in various ways such as by a firewall, one time passwords, encryption programs, digital certificates, user application security, etc. Various combinations of these and/or other security features may be used. In one implementation, these security approaches may be layered to provide a highly secure environment in which one device may interact with another. For example, the security features may require a user to log in before transferring data from one device to another. In other implementations, the security features may require the user to provide the user's credentials or identity which is trusted by the cloud for transferring data over the cloud.

It should be understood that the user device 130 is intended to be representative of a broad category of data processors. The user device 130 may include a processor and memory and in one implementation, the user device 130 may be a computer system that may include a plurality of devices. In one implementation, the user device 130 may be connected to the synchronizer 140. In another implementation, the synchronizer 140 may be a component in the computer 130.

The user device 130 may contain information about the user that is associated with the user device 130. According to example implementations, user information comprises a user's credentials such as, and not limited to, a user name, password, email address, profile photo, and other privacy/security settings. User information may also include, and not limited to, a user's first name, family name, gender, age, address, country, spoken languages, job type, employer, schools, affiliations, etc. User information may also include the list of channels a user owns or has access to view.

The synthesizer 140 may facilitate creating a personal data channel. The synthesizer 140 may allow a user to upload personal content, designate custom characteristics of a personal data channel for distribution of the personal content, and select a group of recipients eligible to receive the personal data channel with its personal content. The synthesizer 140 may be embedded in the user device 130 or may be attached to the user device 130. In another implementation, the synthesizer 140 may be embedded in the multimedia device 150 or may be attached to the multimedia device 150. Each channel that the synthesizer 140 may comprise a stream of content from a given user device (e.g., the user device 130) that is updated on demand or at regular intervals. In one example implementation, the user may upload personal content, such as digitally stored personal photos, a home movie, a slideshow of stored images, etc., to the user device 130. By way of illustration and not by way of limitation, the user device 130 may employ a user interface, via a web page or web portal that may be accessible by a user to manually enter the data, e.g., videos the user recently recorded. The personal data channel may be a collection of personal assets which may include, but not limited to, photos from local systems, Facebook, Flickr, Snapfish, tweets, RSS feeds, photo-derived artifacts (books, collages, animated sequences), personal videos, personally-selected RSS feeds, Facebook updates, publicly shared scheduled items and/or events.

In one implementation, the synthesizer 140 may manage the characteristics of a personal data channel. For example, the synthesizer 140 may integrate a new channel number for a personal channel into a preexisting channel lineup, and decide which proposed recipients have digital rights to receive the newly created personal channel. In another implementation, the personal data channel may dynamically appear integrated into the channel lineup of selected recipients in response to the user uploading personal content.

The synthesizer 140 may comprise a processing device and a non-transitory computer-readable medium. The machine-readable medium may comprise instructions that when executed cause the synthesizer 140 to conduct at least the functions described herein. The computer-readable medium may correspond to any typical storage device that stores machine-readable instructions, such as programming code, software, firmware, or the like. For example, the computer-readable medium may include one or more of a non-volatile memory, a volatile memory, and/or a storage device. Examples of non-volatile memory include, but are not limited to, electronically erasable programmable read only memory (EEPROM) and read only memory (ROM). Examples of volatile memory include, but are not limited to, static random access memory (SRAM) and dynamic random access memory (DRAM). Examples of storage devices include, but are not limited to, hard disk drives, compact disc drives, digital versatile disc drives, optical devices, and flash memory devices. In some implementations, the instructions may be part of an installation package that can be executed by the processing device. In this case, the computer-readable medium may be a portable medium such as a CD, DVD, or flash drive or a memory maintained by a server from which the installation package can be downloaded and installed. In another implementation, the instructions may be part of an application or application already installed. Here, the computer-readable medium may include integrated memory such as a hard drive.

The processing device may be a at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on a machine-readable storage medium, or a combination thereof. The processing device may fetch, decode, and execute instructions stored on the computer-readable medium to implement the functionalities described above.

The multimedia device 150 may be any device capable of processing content information, interacting with a corresponding content stream, and communicating over the network. The multimedia device 150 may be further capable of supporting various operations, such as and not limited to, content viewing, content recording, content play, content forwarding/rewinding, content downloading, content uploading, etc. In one implementation, the multimedia device 150 may include various home entertainment systems such as set top boxes as well as personal computing devices and mobile devices. For example, the multimedia device 150 may include, but are not limited to, desktop computers, notebook computers, cellular network devices such as a smart phone, tablets, computing devices such as a personal data assistant (PDA), network-capable digital cameras, network-capable digital photo frames, network-capable media players, audio/video devices such as network-capable DVD players, Blu-Ray Disk players, audio/video recording devices, network-capable storage devices, plasma TV sets, liquid crystal display TV sets, high definition TV sets, video player/recorder, TV set top boxes, network-capable home appliances, and network-capable game devices such as Nintendo Wii, Sony Playstation, Microsoft XBOX Live, Microsoft XBOX 360, etc. Further, the multimedia device 150 may include a cable box, DVR, Internet video box (e.g., Apple TV, Vudu, or Roku), or any cable, satellite or internet-connected media device.

In one implementation, a display monitor or television set may be connected to each set top box or computing device. It should be noted that while the system 100 illustrated in FIG. 1 includes only one multimedia device, the system may actually comprise a plurality of multimedia devices, and such multimedia devices may be connected via a local network. In another implementation, the multimedia device 150 may be provided with credentials for accessing/receiving content. These credentials may be unique for each user, e.g., a hash function of the user's identifier. Furthermore, they may be encrypted using an encryption key known only to the user (e.g., user's password).

In a further implementation, the multimedia device 150 may be associated with the service provider 160. The service provider 160 may be coupled to the multimedia device 150 via the Internet, a cable hookup, a satellite dish, a wireless transceiver, an over-the-air receiver, etc., or combinations of these. In one implementation, the service provider 160 may include a commercial provider of multimedia programming content (e.g., a television station, satellite headend, cable TV provider, etc.). The multimedia service provider 160 may have subscribers. The subscribers may sign up to receive services from the service provider 160. The service provider 160 may require a subscription fee that the subscribers may need to pay at the time of the initial sign-up. In another implementation, the service provider 160 may offer services for free as long as the subscribers sign up by providing certain personal credentials.

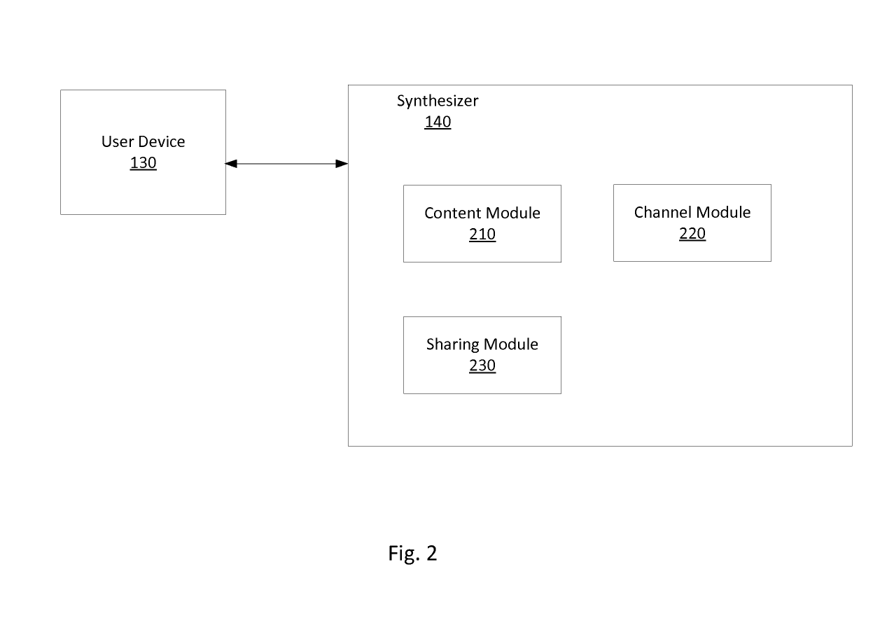

FIG. 2 illustrates the example synthesizer 140 of the system 100 in accordance with an implementation. It should be readily apparent that the synthesizer 140 illustrated in FIG. 2 represents a generalized depiction and that other components may be added or existing components may be removed, modified, or rearranged without departing from a scope of the present disclosure. The synthesizer 140 described herein comprise a number of modules, each with a particular role, as shown in FIG. 2. These modules can be either functions within the computer program product described herein, sub-methods of the method described herein, and/or elements of the system described herein. The synthesizer 140 comprises a content module 210, a schedule module 220 and a sharing module 230, each of which is described in greater detail below. While FIG. 2 illustrates three modules, there may be additional modules or the illustrated modules may be structured differently. Also, although FIG. 2 shows all of these components within a single device (i.e., the synthesizer 140), the components may be physically distributed across multiple devices.

The content module 210 may enable a user to query the database 110 and/or the cloud 120 for identifying personal content using one or a list of search criteria. According to exemplary implementations, the user may use a search engine, enter specific keywords and further tune the search by specifying various limitations, for example and not limited to, the minimum and/or maximum size of the content, the minimum and/or maximum video duration, the content ID, content title, content description, content type, a minimum and/or maximum value for the user rating of the content and/or the content popularity, etc. In another implementation, the user may further tune the search by excluding content items that were streamed some specific period of time ago (e.g., last 10 weeks). In one implementation, the user utilizing the synthesizer 140 to create a personal data channel may specify the sources from which the personal content to be retrieved, and the content search is carried out by the content module 210. In another implementation, the synthesizer 140 may comprise a content recommendation module (not shown in FIG. 2), and the user may get content recommended by using the content recommendation module.

The content recommendation module may recommend content to the user (e.g., channel owner) based on a set of rules. In one implementation, content recommendation is carried out when a user desires to create a channel for the first time. In another implementation, content recommendation is carried out to update and/or to extend the program of an existing channel. According to exemplary implementations, content recommendation can be based on, and not limited to, the channel type, the preferred layout of the content, the preferences of its assigned viewers, or preferences of the user creating the channel, etc. For example, the content recommendation module recommends only children's music for a channel dedicated to children. The content recommendation module may also take into account the content source, i.e., if the user seeks content only from specific folders, the content recommendation module may recommend content from those specified folders.

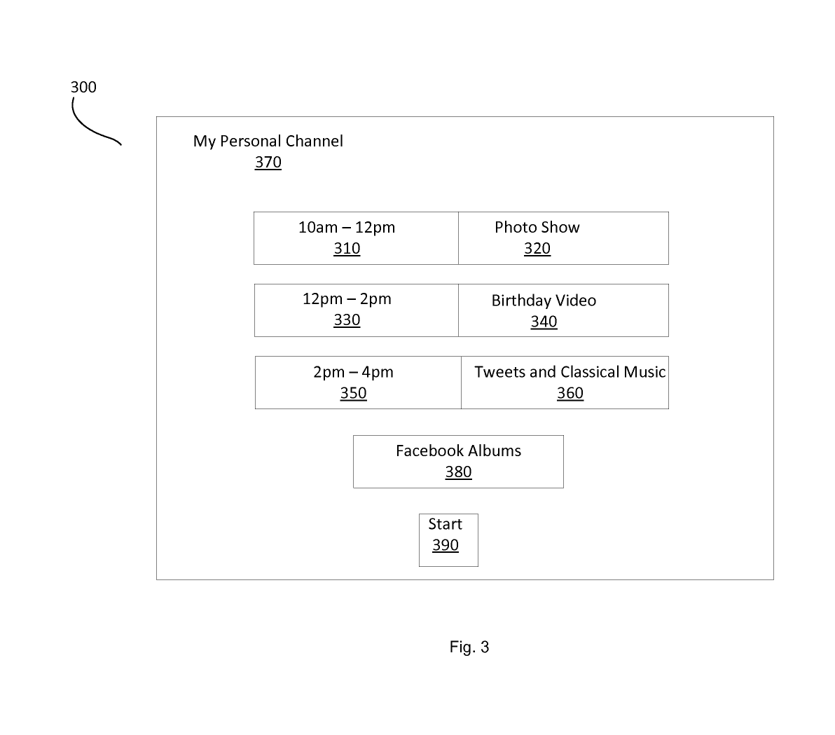

In one implementation, the channel owner may select the content items to be added to the channel after tuning the search results as described above. Such selection may be communicated to the content module 210 by, for example, the user's action of checking boxes associated with the content items, wherein checking the boxes indicates the user's intent to select the content items. In another implementation, the boxes associated with the content items may already be checked by default. In that case, the user may choose to uncheck the boxes, wherein unchecking indicates the user's intent to eliminate the content items from the channel. Alternatively or in addition, the user may add the selected content items to the channel and enter the content scheduling operation. In a further implementation, the user may allow the viewer of the channel to dynamically update the preferences associated with the channel based on the content being viewed. As described in more detail below with respect to FIG. 3, the viewer may update the preferences via an input device or an input option on the viewer interface of the channel.

The channel module 220 may contain different channel information. According to exemplary implementations, the channel information comprise, and not limited to, channel identifier, channel owner, channel description, etc. In one implementation, channel information may comprise metrics and rules for content scheduling, and the channel module 220 may schedule the streaming times of the selected content based on the set of rules. In some implementations, the scheduling of the selected content may be done manually. In other implementations, the scheduling of the selected content may be done via a recommendation engine. According to exemplary implementations, content scheduling for a channel may be based on, but not limited to, the type of the selected content, content popularity, preferences of the channel owner, preferences of the viewers, etc. In another implementation, the channel information may comprise streaming periodicity of the content (e.g., a new image is streamed every minute, and therefore the streaming periodicity is one minute).

In another implementation, the channel information may indicate whether a channel accepts having commercials and/or advertisements. The commercials and/or advertisements may be inserted during the stream of a content item in the channel. In one implementation, the commercials may be inserted within a content stream. In another implementation, the commercials may be inserted at the end of a content stream. In a further implementation, the commercials may be inserted as a hyperlinked text or image displayed on the screen of the multimedia device 150 only after the end of the stream of the content item. In another implementation, the commercial or advertisement content may be pulled from an advertisement sub-database in the database 110.

The channel module 220 may also control the design of the channel. In one implementation, the channel module 220 may be a channel designer as a sub component (not shown in FIG. 2). In another implementation, the channel designer may be a stand-alone module. In some implementations, the user may interact with the channel module 220 via a user interface, and specify how many content items to display per page and how they should be ordered. In another implementation, the user may add selected content items to the channel program as specified by the content module 220, and schedule the newly added content. In a further implementation, the channel module 220 packages the channel design and generates HTML code that the sharing module 230 may distribute the channel to a group of viewers. This code may be embedded in a Web page or in an email, among other methods.

The sharing module 230 may allow the user to specify a list of users (e.g., viewers) to share the personal data channel with. The names of the viewers may be saved on a list, or any information related to the viewers may be stored in a database in the system 100. Alternatively or in addition, the user may remove any unwanted users from the list of viewers to block their access to the user's personal content through the personal channel.

In one implementation, a user may invite another user to view the channel using, by way of example and without limitation, an email address, a social network platform/application such as Facebook, Twitter, LinkedIn, Google Plus, My YearBook, Hi5, Mixi, etc., an instant messaging application such as AOL, Google Gtalk, MSN Messenger, Yahoo Messenger, ICQ, etc., an electronic mail application such as Microsoft Outlook, Mozilla Thunderbird, Hotmail, Gmail, etc., an voice over IP application such as Skype, FaceTime, etc., a gaming application, online discussion groups and blogging forums, etc. The viewers may be identified by an email, social ID (Facebook, Twitter, Google, etc.), Roku ID, etc. In another implementation, the viewers may have profiles. The profiles may include different information, such as a list of preferences, age, address, list of contacts, etc.

According to a further implementation, the sharing module 230 may also manage a list of viewers requesting access to the personal channel and a list of pending invitations from the owner of the channel to other users to view the channel.

In one implementation, a recommendation engine (not shown in FIG. 2) may be used to recommend viewers based on a set of rules. Viewer recommendations may be based, by way of illustration and not by way of limitation, on the existing members of the user's social networks, users having specific interest in common with the user, etc. Such social networks may include Facebook, Twitter, LinkedIn, and the viewers may include family, friends, work colleagues, classmates, etc.

The sharing module 230 may be capable of supporting secure access between the multimedia device 150 and the personal content, such as photos, music, video, slideshows, etc., stored on a home network of the user, or delivered via a personal data channel.

In one implementation, the system 100 may include a licensing manager that performs digital rights management (DRM). In other implementations, built-in DRM technologies may allow delivery of protected digital video, music, and game services to multimedia device 150 and to other devices. DRM may also include communicating copyrights and licensing prospective recipients of the personal media content.

In other implementation, the synthesizer 140 may have a data manager that captures feedback from the viewers in response to the delivery of the personal data channel. In another implementation, a prioritization manager may prioritize delivery of personal data channels to the multimedia device 150 or other devices based on the feedback.

An exemplary screenshot of an example personal data channel 300 is illustrated in FIG. 3 in accordance with an implementation. It should be readily apparent that the personal data channel 300 represents a generalized depiction and that other components may be added or existing components may be removed, modified, or rearranged without departing from a scope of the present disclosure. The actual layout and behavior of the personal channel content may be designed differently. The personal channel 300 described herein comprise by way of example and without limitation, a number of time slots and a list of personal content items associated with those time slots. The personal data channel 300 comprises a photo show 310 at a 10 am-12 pm time slot 320, a birthday video 330 at a 12 pm-2 pm time slot 340, and a list of tweets along with a classical music playlist 350 at a 2 pm-4 pm time slot 360. While FIG. 2 illustrates three examples, there may be additional personal content scheduled to be delivered at additional time slots.

Moreover, in another implementation, the personal content may not be associated with time slots. Instead, the personal data channel 300 may not have scheduled times for playing the photo show 310, birthday video 320 and/or the list of tweets along with the classical music playlist 350. The system 100 may allow the viewers of the personal data channel 300 to select and view the content on demand, and accordingly, the personal data channel may start playing almost instantaneously. The personal data channel 300 may play the personal content at the request of the viewer. Accordingly, if the viewer chooses to view the photo show 310, the viewer can do so by clicking on the photo show 310. In another implementation, the personal data channel 300 may have content that are scheduled to be viewed at a specific time slot in addition to the personal content that are not scheduled for a specific time slot, such as Facebook albums 380. The Facebook albums 380 may be viewed at a time during which no other content is scheduled to be streamed (e.g., 4 pm-10 am).

In one implementation, the personal data channel 300 may include a channel name, e.g., my personal channel 370. By clicking on the channel name on the personal data channel 300, the details on the personal data channel 300 can be shown. The details may include the channel ID, the program of the channel, the content being played, the description of the channel, etc.

In some implementations, the channel design may include buttons or menu position on a toolbar. For example, the viewer of the channel may initiate viewing the personal content shared via the personal data channel 300 by choosing a start button 390 or menu position on a toolbar. In one implementation, the start button may be connected to an aggregator that fetches the latest channel content from the database 110, which may be local to the multimedia device 150 or on a remote server computer. In other implementations, the viewer may access the channel by clicking on an item, clicking on a Web page link through a Web browser, and dragging and dropping a link from a Web browser to the channel database interface. In one implementation, a database in the system 100 may maintain a persistent store containing all of the channels the viewer has selected.

In another implementation, there may be additional buttons for capturing feedback from the viewer(s) of the personal data channel 300. For example, the viewer may dynamically update preferences associated with the channel based on the content being viewed or influence the type of content presented in the personal data channel 300. The viewer may click on a “more” or a “less” buttons (not shown in FIG. 3) to communicate his preference to view more or less of certain content in the personal data channel 300. Accordingly, the system 100 may modify the content based on the viewer's input. In one implementation, the system 100 may modify the personal data channel 300 dynamically. In another implementation, the input from the viewer may be stored to be presented to the user (e.g., the channel owner). The user may review the input and feedback from the viewers of the personal data channel 300 and may adjust the content included in the personal data channel 300.

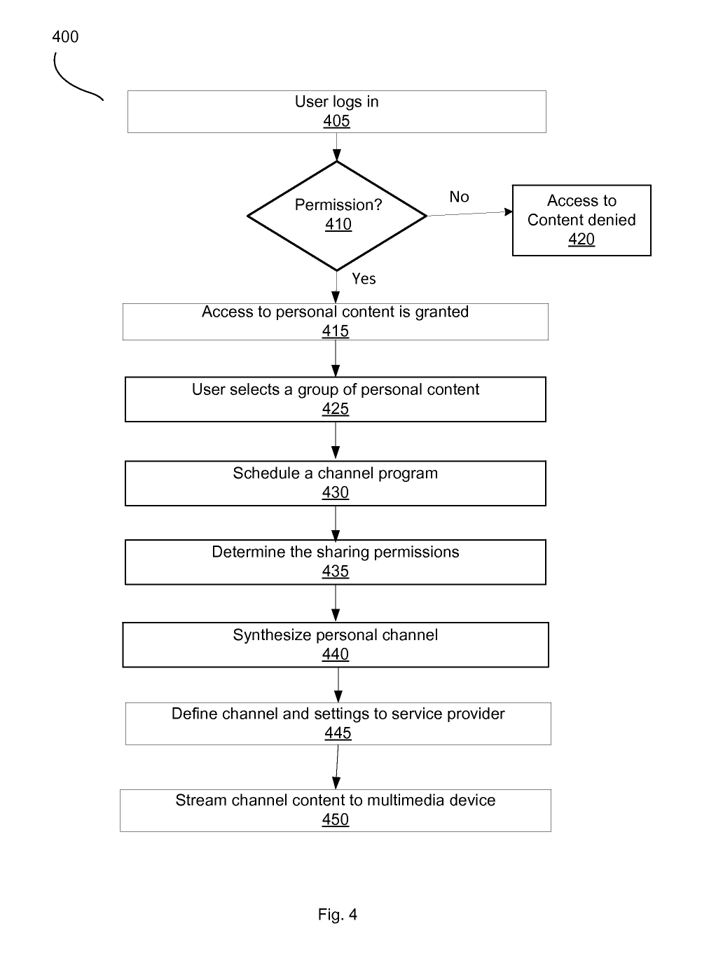

Turning now to the operation of the system 100, FIG. 4 depicts an example process flow diagram 400 in accordance with an implementation. It should be readily apparent that the processes depicted in FIG. 4 represents generalized illustrations, and that other processes may be added or existing processes may be removed, modified, or rearranged without departing from the scope and spirit of the present disclosure. Further, it should be understood that the processes may represent executable instructions stored on memory that may cause a processing device to respond, to perform actions, to change states, and/or to make decisions. Thus, the described processes may be implemented as executable instructions and/or operations provided by a memory associated with a synthesizer 140.

The process 400 may begin at block 405, where a user logs in to access personal content. In particular, this process may involve receiving the user data (e.g., username, password) from the user. At block 410, the system determines whether the user is an authorized user to access personal content. If the user data matches the user credentials associated with the personal content, at block 415, the user profile associated with the user data may be obtained and access to the user's personal data is granted. If the user data received is incorrect, at block 420, access to the user's personal content is denied.

At block 425, the user selects a group of personal content items to create a personal data channel. In particular, this process may involve the user specifying the types of content to be streamed over the channel. For example, as discussed in detail above with respect to FIGS. 1-3, the personal content can be movies, music, photos, combination of these, etc. Moreover, the user may specify the sources of the content to be retrieved. As discussed in detail above with respect to FIG. 2, this may include the user using a search engine and further tuning the search by specifying the minimum video duration, entering specific keywords, excluding content items that were streamed some specific period of time ago (e.g., last 10 weeks). Further, the user may also get content recommended by the content recommendation module.

At block 430, the selected content items are added to a program for the personal data channel. In one implementation, this process may involve allowing the user to manually reposition/change the streaming order of the content items into the channel program. The process may also involve inserting commercials into the channel program. In particular, depending on the content type, recommended commercials may be inserted, and if permissible, the user may replace a recommended commercial as the user may wish. Moreover, the process may also involve storing the channel program in a database.

At block 435, the user determines at least one viewer for the personal channel. In particular, this process may involve determining who to share the personal channel with, such as friends & family, only family, only children, people living in a specific location, only people speaking a specific language, etc. Further, this process may involve determining at least one multimedia device associated with the at least one viewer.

At block 440, once the user confirms the personal data channel design and settings, the processing of synthesizing the personal data channel is executed. The synthesizer may be a part of the user device or may be a device attached to the user device and/or the multimedia device. Moreover, the synthesizer may be a part of the multimedia device.

Once executed, at block 445, the personal data channel is defined to a service provider. In particular, this process may involve the synthesizer providing the sharing permissions associated with the personal channel to the service provider. Moreover, this process may also involve the user device transmitting a request signal for requesting to change channel settings to the service provider. On the basis of this request signal, the service provider switches the receiving channel to the personal channel requested by the user device. In response, the service provider may return a response indicative that the channel setting has been done to the user device.

At block 450, the content items required by the personal channel may be shared with at least one multimedia device. In one implementation, the sharing may be direct to the multimedia device from the user device. In another implementation, the delivery may be performed through a cloud. In a further implementation, where the synthesizer is to function as part of the multimedia device, the sharing may not be necessary as the synthesis is performed in the multimedia device.

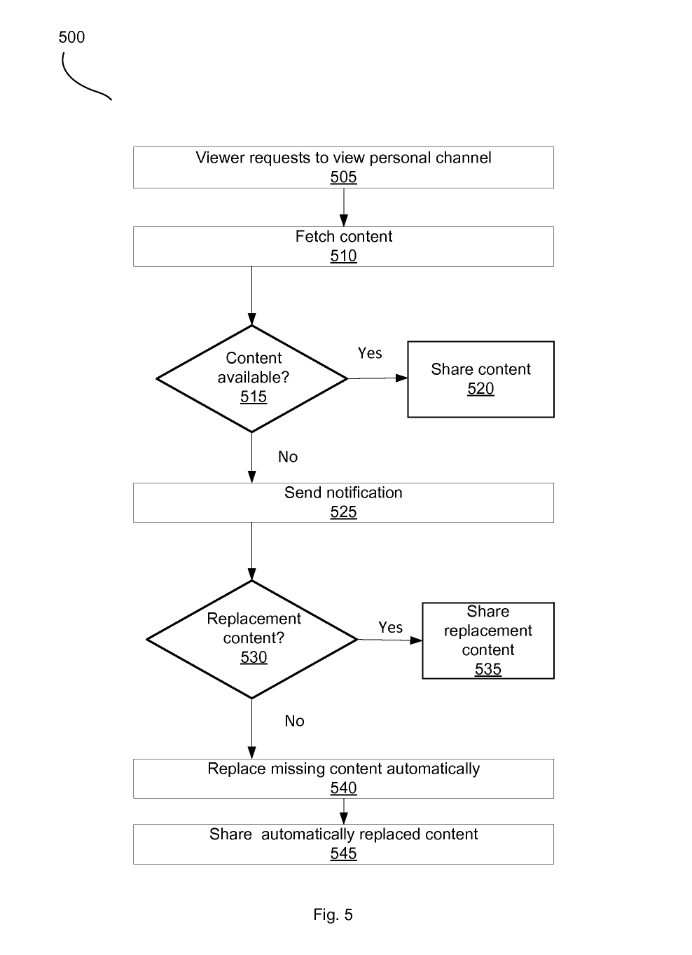

FIG. 5 illustrates an example process flow diagram 500 in accordance with another implementation. Similar to FIG. 4, FIG. 5 represents generalized illustrations, and that other processes may be added or existing processes may be removed, modified, or rearranged without departing from the scope and spirit of the present disclosure.

The process 500 may begin at block 505, where a viewer at multimedia device may request to view the personal channel, the synthesis of which is described above in detail with respect to FIG. 4. In response to this request, at block 510, the latest channel content is fetched from the various content sources.

In some situations, a content item scheduled to be streamed into a channel may become unavailable. At block 515, the system checks the availability of the selected content. If the content item is available, at block 520, the content is shared with the multimedia device. If the content item scheduled to be streamed into the personal channel is unavailable, at block 525, a notification alert may be issued to the user and/or to the multimedia devices. At block 530, the system determines if the user may manually replace the unavailable content items following the notification alert message. If the user can manually replace, at block 535, the replacement content item is shared. If the user cannot, at block 540, a replacement to the missing content item may be automatically decided by the system, and at block 545, the automatically replaced content is shared.

In certain implementations, the personal channel may disappear when the personal content is no longer available or shared.

While the above disclosure has been shown and described with reference to the foregoing examples, it should be understood that other forms, details, and implementations may be made without departing from the spirit and scope of the disclosure that is defined in the following claims.

What is claimed is:

1. A method for sharing a personal data channel, comprising:
collecting a selection of personal data associated with a user;
synthesizing, at a user device, a personal data channel using the selected personal data; and
delivering the personal data channel to at least one multimedia device.

2. The method of claim 1, wherein the at least one multimedia device is associated with at least one user eligible to receive the personal data channel.

3. The method of claim 1, further comprising:
receiving a list of users eligible to receive the personal data channel;
identifying multimedia devices associated with the list of users; and
offering the personal data channel to the identified multimedia devices associated with the list of users.

4. The method of claim 1, wherein the selection of personal data has a plurality of data types.

5. The method of claim 4, wherein the plurality of data types comprises at least one or combination of photo, video, audio, and text.

6. The method of claim 1, wherein collecting the selection of personal data associated with the user further comprises collecting the selection of personal data from at least one of local data sources and a cloud data source.

7. The method of claim 1, wherein delivering the personal channel to the at least one multimedia device further comprises delivering the personal channel through a device-to-device connection, or delivering the personal channel remotely through a cloud data source.

8. The method of claim 1, wherein synthesizing the personal data channel, at the user device, using the selected personal data further comprises:
receiving a channel organization specification; and
creating the personal data channel based on the channel organization specification.

9. The method of claim 1, further comprising:
capturing feedback at the at least one multimedia device in response to the delivery of the personal data channel; and
prioritizing delivery of personal data channels to the at least one multimedia device based on the feedback.

10. The method of claim 1, further comprising:
capturing feedback at the at least one multimedia device in response to the delivery of the personal data channel; and
modifying the personal data channel based on the feedback.

11. The method of claim 1, further comprising inserting advertisements into the personal data channel based on the selected personal data.

12. The method of claim 1, further comprising managing digital rights related to personal data to be delivered over the personal data channel.

13. A system for generating a personal data channel comprising:
a content module to collect a selection of personal data associated with a user; and
a channel module to synthesize, at a multimedia device, a personal data channel using the collected personal data.

14. The system of claim 13, wherein the content module collects the selected personal data from at least one of a user device and a cloud data source.

15. The system of claim 13, wherein the personal data associated with the user has a plurality of data types.

16. The system of claim 13, further comprising a sharing module to share the personal data channel with at least one other multimedia device.

17. The system of claim 13, further comprising:
a data manager to capture feedback related to the personal data channel from at least one viewer at the multimedia device; and
a prioritization manager to prioritize delivery of personal data channels to the multimedia device based on the feedback from the viewer.

18. The system of claim 13, further comprising an advertisements module to insert commercials into the personal data channel based on the selected personal data.

19. The system of claim 13, further comprising a licensing manager to manage digital rights related to personal data to be delivered over the personal data channel.

20. A non-transitory computer-readable medium comprising instructions which, when executed, cause a system to:
collect a selection of personal data associated with a user;
synthesize, at a user device, a personal data channel using the selected personal data; and
deliver the personal data channel to at least one multimedia device.
